(19) United States
(12) Patent Application Publication
(10) Pub. No.: US 2025/0316053 A1
(43) Pub. Date: Oct. 9, 2025

(54) POINT CLOUD FEATURE RECOGNITION AND LABELING ALGORITHM BASED ON IMPROVED POINTNET++

(71) Applicant: Dalian University of Technology, Dalian City (CN)

(72) Inventors: Xin CHENG, Dalian City (CN); Ji WANG, Dalian City (CN); Shilin HUO, Dalian City (CN); Rui LI, Dalian City (CN); Xiao LIU, Dalian City (CN)

(73) Assignee: Dalian University of Technology, Dalian City (CN)

(21) Appl. No.: 18/685,518

(22) PCT Filed: Jan. 17, 2024
(86) PCT No.: PCT/CN2024/072690

§ 371 Date: Jun. 19, 2025

(30) Foreign Application Priority Data
Jul. 27, 2023 (CN) 202310932996.9

(51) Int. Cl. G06V 10/26; G06V 10/762; G06V 10/77; G06V 10/82; G06V 20/64

(52) U.S. Cl. CPC G06V 10/267; G06V 10/762; G06V 10/7715; G06V 10/82; G06V 20/64

(57) ABSTRACT

The invention discloses a point cloud feature recognition and annotation algorithm based on improved PointNet ++. The algorithm includes a supervoxel growth method suitable for deep learning networks and a deep learning network suitable for dense scanning data. This method improves PointNet ++ and constructs a deep learning network suitable for large-scale point cloud recognition. While processing point clouds in each region, it considers the relationship between point clouds in each area, it solves the technical problem that the traditional PointNet series network cannot handle large-scale point clouds. A super-voxel growth method for voxelized point cloud calibration is proposed, which is suitable for determining the characteristic parameters in voxels with a strong resolution, easy calculation, and strong robustness, and realizes fast, efficient, and meaningful voxelized point cloud calibration.

### TECHNICAL FIELD

The invention belongs to the field of three-dimensional data processing and deep learning, and specifically relates to a point cloud feature recognition and labeling method suitable for dense point cloud. More specifically, the invention relates to a point cloud feature recognition and labeling algorithm based on improved PointNet++.

### BACKGROUND ART

Point cloud recognition based on unordered points: PointNet is the forerunner of this kind of problem, based on the idea of order matters, this method designs a deep network that is independent of unordered input, meaningful local points, and free from rigid body transformation for the original point cloud. The construction of this network is different from the convolutional network, its basic layer is a symmetric function that relies on a multi-layer sensing network to cooperate for full input, for spatial transformation, the transformation network T-Net is introduced, and finally integrated into the segmentation network to present global features. The network does not rely on convolution promotion, but the effective meaning of each step remains to be discussed, and the initial weight is equal to the number of point cloud points, so the calculation amount of the measurement object with a large number of points is often unbearable. Compared with the PointNet network, the PointNet++ network adds a hierarchical structure to extract features at different scales. Similar to the feature pyramid in the image, the scale increases, and the receptive field continues to increase.

Point cloud simplification: The method of point cloud downsampling is mainly divided into two kinds, uniform sampling and non-uniform sampling. As the name implies, the point cloud points after uniform sampling are arranged neatly and the density is uniform, which can ensure that each area is sampled; the distance between point clouds obtained by non-uniform sampling is different, and the results sampled in each area depend on the point density.

The supervoxel is a set, and the elements of the set are voxels. The essence of the voxel is a small square. The purpose of supervoxel clustering is not to segment a specific object, it over-segments the point cloud, divides the scene point cloud into many small blocks, and studies the relationship between each small block.

The existing related patents only deal with a small number of point clouds, and more cloud information is lost during the processing. In the patent of the 3D point cloud segmentation method and device based on the moving least squares method and supervoxel, the point cloud data processed by octree is voxelized and divided into voxels of the same size. Each voxel is a cube voxel, and the centroid of all points in the cube is used to replace the original point cloud, resulting in oversimplification of the point cloud, and this patent is only used for small-scale point clouds.

### SUMMARY

The invention discloses a point cloud feature recognition and labeling algorithm based on improved PointNet++, this method includes two parts: a supervoxel growth method suitable for deep learning networks and a deep learning network suitable for dense scanning data.

### 1. Supervoxel Growth Method Suitable for Deep Learning Networks

Based on a current voxel growth theory, voxelizing a point cloud and pre-defining feature parameters of each voxel; in order to comprehensively consider a distribution state of point clouds in voxels, selecting feature parameters, formulating growth standards and growth thresholds, growing each growth area, and guaranteeing that several point clouds in each growth area is consistent; this method is suitable for determining the feature parameters in voxels with strong resolution, easy calculation and strong robustness, and a fast, efficient and meaningful voxelized point cloud calibration is realized.

### 2. Deep Learning Network Suitable for Dense Scanning Data

The design is based on PointNet++ network, which is divided into a pre-processing module, an original PointNet++ network backbone module, and a post-processing module.

### 1. Pre-Processing Module:

Putting each growth area grown by the method described in Step 1 into the pre-processing module in batches, the pre-processing module consists of three Set Abstraction layers.

### 2. Original PointNet++ Network Backbone Module:

Putting point cloud features obtained by the pre-processing module and centroid information of each growth area grown in Step 1 into the original PointNet++ network backbone module, the original PointNet++ network backbone module consists of three Set Abstraction layers and three Feature Propagation layer, and obtaining a new point cloud feature dimension finally.

### 3. Post-Processing Module:

Putting point cloud feature information obtained by a calculation of the original PointNet++ network backbone module and point cloud feature information obtained by the pre-processing module into the post-processing module in turn according to a batch of each growth area when it is placed in the pre-processing module; the post-processing module consists of three Feature Propagation layers, three fully connected layers (FC) and two Dropout layers.

For the above technical scheme, furthermore, an algorithm for completing an area growth includes the following steps: First, using a PCA method and a quadratic surface equation to traverse the voxels, and obtaining the feature parameters of each voxel by three-dimensional coordinate information, color, and quantity of the point cloud in the voxel; then generating seed voxels randomly, and searching adjacent voxels from the seed voxels, determining whether the voxels are included in the growth area according to set growth criteria and growth thresholds, terminating the method until all voxels in the area complete growth and a growth process doesn't continue.

For the above technical scheme, furthermore, randomly growing process can be carried out by a single seed voxel or a multi-seed parallel growth.

For the above technical scheme, furthermore, the feature parameters include 14 parameters: 3 normal vector parameters, 1 curvature parameter, 3 color parameters, 1 density parameter, and 6 quadric surface fitting parameters.

For the above technical scheme, furthermore, the Set Abstraction layer in the pre-processing module, first, forming local point cloud clusters by down-sampling and grouping the input growth area, and then putting the local point cloud clusters into a multi-layer perceptron to increase a feature dimension of the point cloud; finally, performing a local maximum pooling to obtain the local global features.

For the above technical scheme, furthermore, each growth area described in the pre-processing module contains three-dimensional coordinates of points, semantic information, etc.

For the above technical scheme, furthermore, since the point cloud is down-sampled in the Set Abstraction layer, first, up-sampling the Feature Propagation layer by linear interpolation, and restoring the number of point clouds in each growth area to the number before the down-sampling using the Set Abstraction layer, and then using the multi-layer perceptron to reduce the feature dimension of the point cloud; finally, obtaining a category of each point by three fully connected layers and two Dropout layers.

For the above technical scheme, furthermore, the Dropout layer can solve the problem that the trained model is easy to produce over-fitting because of too many parameters of the model and too few training samples.

Compared with the existing technology, the invention has the following beneficial effects:
(1) The invention proposes a supervoxel growth method that is suitable for determining the feature parameters in voxels with a strong resolution, easy calculation, and strong robustness and realizes fast, efficient, and meaningful voxelized point cloud calibration.
(2) The invention improves PointNet++ and constructs a deep learning network suitable for dense point cloud recognition, while processing point clouds in each area, the relationship between point clouds in each area is considered.
(3) The technical problem that the traditional PointNet series network cannot handle dense point clouds is solved.

### BRIEF DESCRIPTION OF THE DRAWINGS

FIG. 1 is a schematic diagram of six adjacent voxels used in the embodiment of the invention.

FIG. 2 is a schematic diagram of the supervoxel growth method used in the embodiment of the invention.

FIG. 3 is a deep learning network diagram suitable for dense scanning data in the embodiment of the invention.

FIG. 4 is a prediction effect diagram of the deep learning network suitable for dense scanning data in the embodiment of the invention.

FIG. 5 is a prediction effect diagram of the deep learning network suitable for dense scanning data in the embodiment of the invention.

### DETAILED DESCRIPTION OF THE EMBODIMENTS

The following is a complete description of the embodiment of the invention, a detailed embodiment and a specific calculation process are given, but the protection scope of the invention is not limited to the following embodiment.

The invention uses a supervoxel growth method suitable for deep learning networks.
(1) Based on the current voxel growth theory, the point cloud is voxelized and the feature parameters of each voxel are predefined.
Step 1, the maximum values Xmax, Ymax, Zmax and minimum values Xmin, Ymin, Zmin on the X, Y, and Z axes are obtained according to the point cloud coordinates.
Step 2, the side lengths of voxels Lx, Ly, and Lz are set, the original point cloud is divided into cube voxels with a size of Lx×Ly×Lz, and the number of voxels Dx, Dy, and Dz on the X, Y, and Z axes of the point cloud are calculated.

$$\{ \begin{matrix}{D}_{x} & = ( {X}_{max} - {X}_{min} ) // {L}_{x} + 1 \\ {D}_{y} & = ( {Y}_{max} - {Y}_{min} ) // {L}_{y} + 1 \\ {D}_{z} & = ( {Z}_{max} - {Z}_{min} ) // {L}_{z} + 1\end{matrix}$$

Step 3, the voxel index h of each point in the point cloud is calculated, the points with the same index are put into the same voxel, and their voxel indexes are stored, so as to obtain the information of the points in each voxel.

$$\{ \begin{matrix}{h}_{x} & = ( x - {X}_{min} ) // {L}_{x} \\ {h}_{y} & = ( y - {Y}_{min} ) // {L}_{y} \\ {h}_{z} & = ( z - {Z}_{min} ) // {L}_{z}\end{matrix}$$

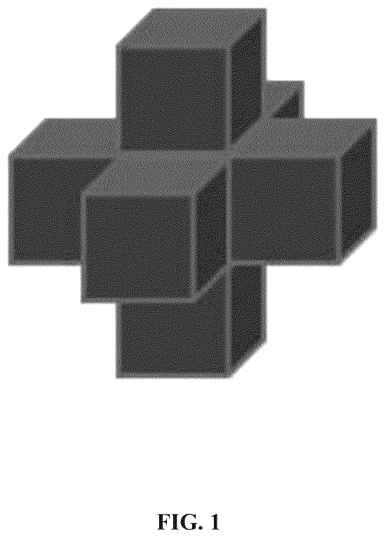

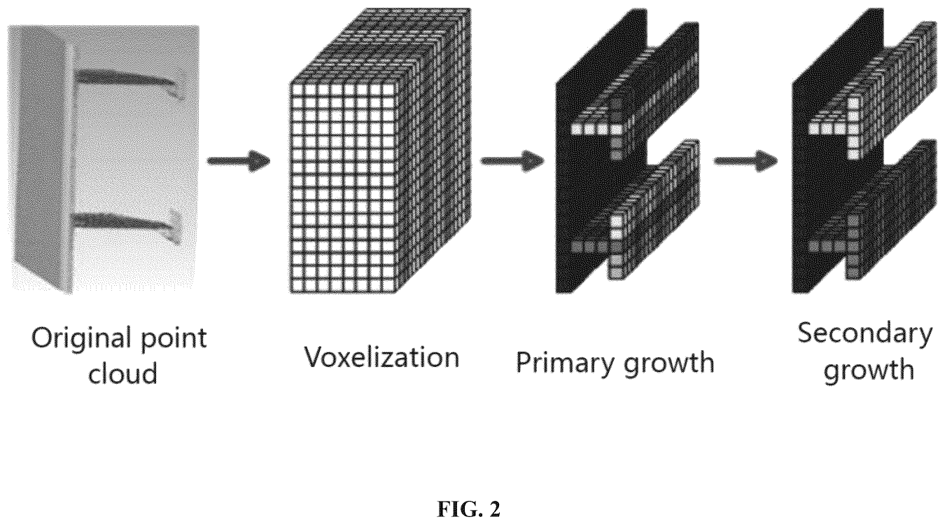

Step 4, through the three-dimensional coordinates of the points in each voxel, the normal vector and curvature of each voxel are obtained by PCA method; the quadratic surface parameters of each voxel are calculated by using the quadratic surface equation; the color information of each voxel is calculated by the color information of the interior points of each voxel; the density of each voxel is calculated by the number of interior points of each voxel.
(2) In order to comprehensively consider the distribution state of point clouds in voxels, the feature parameters are selected, the growth standards and growth thresholds are formulated, each growth area is grown, and the number of point clouds in each growth area is guaranteed to be consistent.
Step 5, a voxel is selected as the seed voxel, and the neighborhood is searched from the seed voxel, the neighborhood is the six voxels adjacent to its front, back, left, right, upper, and lower position, as shown in FIG. 1, it shows six adjacent voxels of the seed voxel in the space and coplanar with the seed voxel. If the normal vector angle, curvature difference, color difference, density difference, and quadratic surface fitting parameter difference between adjacent voxels and seed voxels meet the set threshold requirements, the adjacent voxels are included in the growth area, otherwise, the adjacent voxels are removed. The algorithm terminates until all voxels in the area have completed growth and the growth process cannot be continued. A single voxel is transformed into an area composed of a series of voxels through area growing. Because a 90-degree angle is set between the components of some components, the two components cannot be grown together when the area is grown, so secondary growth is required. Firstly, the area after the first growth is divided, and the area with fewer voxels in the area is separated from the area with more voxels. The area with more voxels is no longer subjected to secondary growth, and the area with more voxels is subjected to secondary growth. The criterion of the secondary growth is that there are adjacent voxels in the voxels of two areas, for example, voxel A is included in area one, voxel B is included in area two, and voxel A and voxel B are adjacent, the two areas are merged into one area. Each secondary growth merges two areas with adjacent voxels until the number of areas obtained by the n+1-th secondary growth is consistent with the number of areas obtained by the n-th secondary growth, and the growth stops. The growth effect is shown in FIG. 2. FIG. 2 shows that the original point cloud is first voxelized, followed by the initial growth according to the established growth criteria, and then the areas that meet the secondary growth criteria are merged through the above secondary growth.
Step 6: The points in the voxels in each area are randomly sampled and down-sampled to N points, the number of areas is limited to M1; if the number of areas after supervoxel growth is more than M1, M1 areas are randomly selected; if the number of areas after supervoxel growth is less than M1, several areas are randomly replicated and supplemented to M1 areas.

The architecture is based on PointNet++ network, which is divided into a pre-processing module, an original PointNet++ network backbone module, and a post-processing module.

### 1. Preprocessing Module:

The point cloud information in each growth area grown by the method described in (2) is put into the pre-processing module in batches, the pre-processing module consists of three Set Abstraction layers.

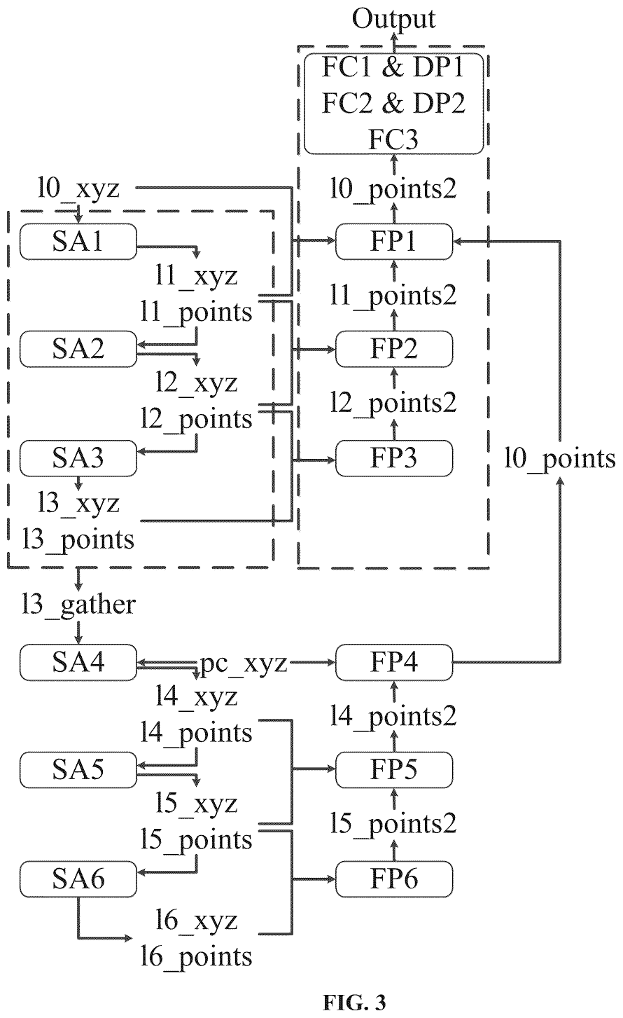

The deep learning network processes samples with a size of (B, M1×N, 3+C0) each time, B is the number of samples entered in each batch, M1 is the number of areas, N is the number of points in each area, and (3+C0) represents the three-dimensional coordinate information and other semantic information of points. First, the sample is changed to a size of (B×M1, N, 3+C0), and the point cloud is input k times in the pre-processing module, each input contains a point cloud with a size of (M2, N, 3+C0), k=B×M1//M2. As shown in FIG. 3, after Set Abstraction 1 (SA1), the size of output 11_xyz is (M2, N1, 3), the size of 11_points is (M2, N1, 128), N1 is the number of points after down-sampling through SA1, 128 is the number of features; the 11_xyz and 11_points are input into SA2, after SA2, the size of the output 12_xyz is (M2, N2, 3), and the size of 12_points is (M2, N2, 256); N2 is the number of points after down-sampling through SA2, and 256 is the number of features; 12_xyz and 12_points are input into SA3, after SA3, the size of the output 13_xyz is (M2, 1, 3), the size of 13_points is (M2, 1, 512), 1 is the number of points after SA3 down-sampling, and 512 is the number of features. The calculation process of SA layer takes SA1 as an example, firstly, N points are divided into N1 groups by farthest point sampling and grouping, and there are several points in each group, such as X points, the size of the obtained 11_xyz is (M2, N1, 3), and the size of 11_points is (M2, N1, X, 3+C0); then the 11_points are converted to (M2, 3+C0, X, N1) and put into the multi-layer perceptron for feature transformation, the 11_points are changed to (M2, 128, X, N1), and finally the local maximum pooling is performed, 11_points becomes (M2, 128, N1), and then becomes (M2, N1, 128).

### 2. Original PointNet++ Network Backbone Module:

The point cloud features obtained by the pre-processing module and centroid information of each growth area Step 1 are input into the original PointNet++ network backbone module, the original PointNet++ network backbone module consists of three Set Abstraction layers and three Feature Propagation layers, and finally, new point cloud features are obtained.

The 13_points obtained by the k-input point cloud are merged to obtain the 13_gather, which is considered as the feature of the center point of each area, the size is (B×M1, 1, 512), and then converted into (B, M1, 512). Meanwhile, the center point of each growth area is obtained, and the pc_xyz is obtained, the size is (B, M1, 3). As shown in FIG. 3, pc_xyz and 13_gather are put into the original PointNet++ network backbone module. After SA4, the size of the output 14_xyz is (B, N4, 3), the size of 14_points is (B, N4, 128), N4 is the number of points after down-sampling through SA4, 128 is the number of features; the 14_xyz and 14_points are input into SA5, after SA5, the size of the output 15_xyz is (B, N5, 3), the size of 15_points is (B, N5, 256), N5 is the number of points after down-sampling through SA5, 256 is the number of features; the 15_xyz and 15_points are input into SA6, after SA6, the size of the output 16_xyz is (B, 1, 3), the size of 16_points is (B, 1, 1024), 1 is the number of points after down-sampling through SA6, 1024 is the number of features. 15_xyz, 15_points, 16_xyz, 16_points are input into FP6, the distance between 15_xyz and 16_xyz is calculated, the nearest three points to each point in 15_xyz and 16_xyz are found, a weight is given to the three points according to the principle that the weight is smaller when the distance is larger, the weight is multiplied by its feature to obtain the feature 15_points2 of the interpolation point, and then 15_points2 is spliced with 15_points to obtain 15_points2 after feature splicing, then 15_points2 after feature splicing is put into the multi-layer perceptron to obtain new features, and the final size of 15_points2 is (B, N5, 256). Similarly, 14_xyz, 14_points, 15_xyz, 15_points2 are input into FP5, and the size of 14_points2 is (B, N4, 128). Similarly, pc_xyz, 13_gather, 14_xyz, 14_points2 are input into FP4, and the size of 10_points is (B, M1, 128).

### 3. Post-Processing Module:

The point cloud feature information obtained by the calculation of the original PointNet++ network backbone module and the point cloud feature information obtained by the pre-processing module are put into the post-processing module in turn according to the batch of each growth area when it is placed in the pre-processing module; the post-processing module consists of three Feature Propagation layers, three fully connected layers (FC) and two Dropout layers.

As shown in FIG. 3, because the pre-processing module adopts the batch input, the post-processing module inputs the point cloud information 12_xyz, 12_points, 13_xyz, 13_points obtained in the corresponding pre-processing module of the same batch processing into FP3, and the size of 12_points2 is (M2, N2, 256); 11_xyz, 11_points, 12_xyz, 12_points2 are input into FP2, and the size of 11_points2 obtained is (M2, N1, 128); the 10_points are separated k times in order and transformed into (M2, 1, 128), and then it is transformed into (M2, N, 128). 10_xyz, 10_points, 11_xyz, 11_points2 are input into FP1, the purpose of adding 10_points here is to consider the relationship between the areas of the sample, and the size of 10_points2 is (M2, N, 128).

Then it is put into the first fully connected layer (FC), Dropout layer (DP), and the second fully connected layer (FC), Dropout layer (DP), and the third fully connected layer in turn. The obtained point cloud size is (M2, N, class), and class is the number of classifications. Finally, 10_points2 obtained by the k-input point cloud is merged, and the data obtained by the transformation is (B, M1×N, class), that is, the category of each point is predicted.

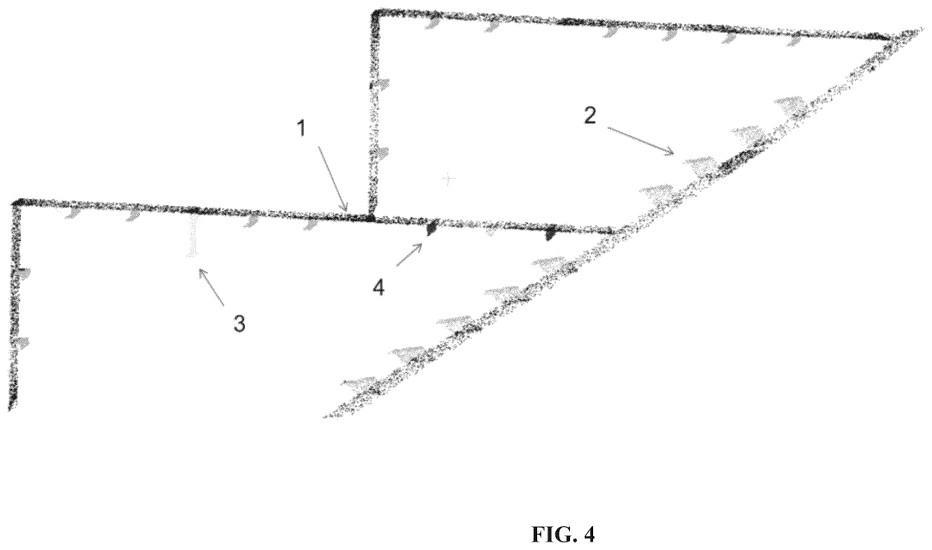

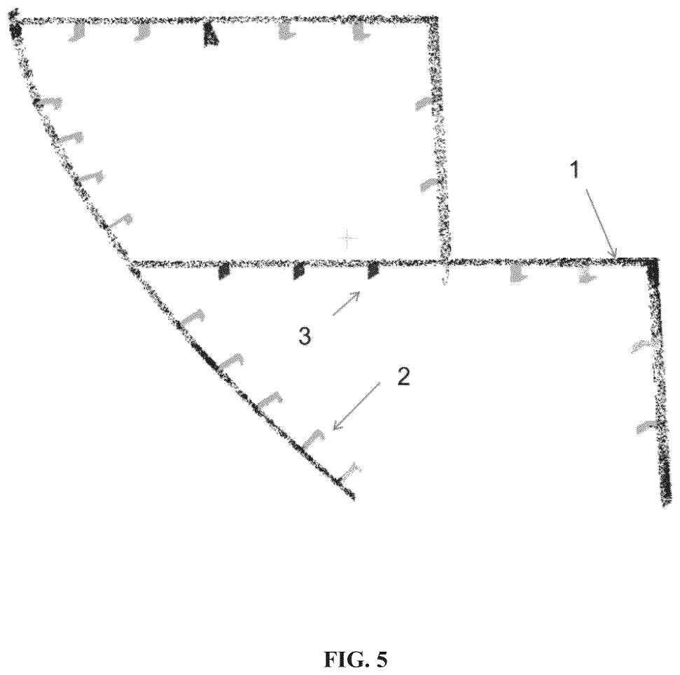

The prediction effect of the network is shown in FIG. 4 and FIG. 5. In FIG. 4, arrow 1 refers to the plate, arrow 2 refers to the ball flat steel, arrow 3 refers to the T profile, and arrow 4 refers to the flat steel; in FIG. 5, arrow 1 refers to the plate, arrow 2 refers to the ball flat steel, and arrow 3 refers to the flat steel. This network can effectively divide the dense point cloud into several categories according to the types of components they have, and realize the efficient identification and labeling of large-scale point set data.

The above embodiment elaborates on the design of a point cloud feature recognition and labeling algorithm based on improved PointNet++. This method ensures the application feasibility of deep learning methods in large-scale dense point set data through supervoxel growth and deep learning network and can realize efficient recognition and labeling of large-scale point set data.

As mentioned above, it is only the better embodiment of the invention, which is not a limitation to the scope of protection of the invention. The technical personnel in this field should cover the changes or replacements that can be easily imagined within the technical scope disclosed by the invention. Therefore, the scope of protection of the invention should be subject to the scope of protection of the claims.

What is claimed is:

1. A point cloud feature recognition and labeling algorithm based on improved PointNet++, comprising the following steps:
Step 1, supervoxel growth method suitable for deep learning networks
based on a current voxel growth theory, voxelizing a point cloud and pre-defining feature parameters of each voxel; in order to comprehensively consider a distribution state of point clouds in voxels, selecting feature parameters, formulating growth standards and growth thresholds, growing each growth area, and guaranteeing that several point clouds in each growth area are consistent;
Step 2, deep learning network suitable for dense scanning data
the design is based on PointNet++ network, which is divided into a pre-processing module, an original PointNet++ network backbone module, and a post-processing module; wherein,
I. pre-processing module:
putting each growth area obtained by the method described in Step 1 into the pre-processing module in batches, the pre-processing module consists of three Set Abstraction layers;
II. original PointNet++ network backbone module:
putting point cloud features obtained by the pre-processing module and centroid information of each growth area in Step 1 into the original PointNet++ network backbone module, the original PointNet++ network backbone module consists of three Set Abstraction layers and three Feature Propagation layer, and obtaining a new point cloud feature dimension finally.
III. Post-processing module:
putting point cloud feature information obtained by a calculation of the original PointNet++ network backbone module and point cloud feature information obtained by the pre-processing module into the post-processing module in turn according to a batch of each growth area when it is placed in the pre-processing module; the post-processing module consists of three Feature Propagation layers, three fully connected layers (FC) and two Dropout layers.

2. The algorithm according to claim 1, wherein an algorithm for completing an area growth comprises the following steps: first, using a PCA method and a quadratic surface equation to traverse the voxels, and obtaining the feature parameters of each voxel by three-dimensional coordinate information, color, and quantity of the point cloud in the voxel; then generating seed voxels randomly, and searching adjacent voxels from the seed voxels, determining whether the voxels are included in the growth area according to set growth criteria and growth thresholds, terminating the method until all voxels in the area complete growth and a growth process doesn't continue.

3. The algorithm according to claim 1, wherein randomly growing process can be carried out by a single seed voxel or a multi-seed parallel growth.

4. The algorithm according to claim 1, wherein the feature parameters comprise 14 parameters: 3 normal vector parameters, 1 curvature parameter, 3 color parameters, 1 density parameter, and 6 quadric surface fitting parameters.

5. The algorithm according to claim 1, wherein the Set Abstraction layer in the pre-processing module, first, forming local point cloud clusters by down-sampling and grouping an input growth area, and then putting the local point cloud clusters into a multi-layer perceptron to increase a feature dimension of the point cloud; finally, performing a local maximum pooling to obtain local global features.

6. The algorithm according to claim 1, wherein each growth area described in the pre-processing module contains three-dimensional coordinates of points and semantic information.

7. The algorithm according to claim 1, wherein since the point cloud is down-sampled in the Set Abstraction layer, first, up-sampling the Feature Propagation layer by linear interpolation, and restoring the number of point clouds in each growth area to the number before the down-sampling using the Set Abstraction layer, and then using the multi-layer perceptron to reduce the feature dimension of the point cloud; finally, obtaining a category of each point by three fully connected layers and two Dropout layers.

8. The algorithm according to claim 1, wherein the Dropout layer can solve the problem that a trained model is easy to produce over-fitting because of too many parameters of the model and too few training samples.
